(19) United States
(12) Patent Application Publication
(10) Pub. No.: US 2004/0085454 A1
(43) Pub. Date: May 6, 2004

(54) Digital camera capable of transforming the audio input to its picture immediately into a readable illustration and transmitting same

(76) Inventor: Ming-Zhen Liao, Yunlin (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/286,833

(22) Filed: Nov. 4, 2002

(51) Int. Cl. H04N 5/225

(52) U.S. Cl. 348/207.99

(57) ABSTRACT

A versatile digital camera disclosed is capable of transforming the audio input to its picture immediately into a readable characterized illustration and transmitting same by way of existing radio communication system or global internet to a specified receiver or to display on a visual display terminal without loosing fidelity of the picture thereby saving extra manpower and time otherwise may be consumed for preparing supplementary illustration for a silent picture as that produced by the conventional technique.

### BACKGROUND OF THE INVENTION

1. Field of the Invention

The present invention relates to digital camera capable of transforming the audio input to its picture immediately into a readable illustration and transmitting same, in particular, to a digital camera whose picture can be affixed a readable characterized illustration transformed from the sender's voice input and transmitted to the receiver or displayed on the visual display terminal.

2. Description of the Prior Art

A digital camera has now become one of the popular electronic consumer's favorite products in place of a conventional camera due to its easily operative property without need of negative films. Even as such, the current manufactures of digital camera can only endeavor to upgrade the picture element fidelity, but no other extra significant function can be added to the digital camera.

It is well understood that both conventional and digital cameras are only usable to provide a silent image, a further detail descriptive illustration should be supplied additionally to accompany the picture so as to make the information contained in the picture perfect.

Owing to the progress of international communication, the digital information can be immediately transmitted globally through international internet. Imagine how it is so fantastic that a young couple staying in two places far apart from each other is able to exchange the active and vivid digital camera pictures affixing a readable information which helps appeal with each other for the profound love hidden deeply in the heart!

In view of increasing consideration of the public in this respect, the present inventor has endeavor to find out the solution to satisfy the public demand with long time efforts and presently has realized the digital camera of the present invention.

### SUMMARY OF THE INVENTION

Accordingly, the main object of the present invention is provide a digital camera capable of transforming the audio input to its picture immediately into a readable characterized illustration and transmitting same by way of existing radio communication system or internet globally to a specified receiver or to display on a visual display terminal without loosing fidelity of the picture thereby saving extra manpower and time for preparing supplementary illustration for the silent picture.

To achieve the above mentioned object, the digital camera of the present invention comprises an audio input device for inputting audio signals; a voice Identification device connected to the audio input device for receiving the audio signals therefrom, and storing the readable characterized information transformed from the audio signals via the procedures of identification and processing using identification software and other system elements in a digital picture; a transmission interface for transmitting the output digital picture which storing the readable characterized information; and a processing unit provided with several operational keys on the surface of the digital camera for operating and controlling above mentioned devices.

### BRIEF DESCRIPTION OF THE DRAWINGS

The accompanying drawings, which are included to provide a further understanding of the invention and incorporated in and constitute a part of this specification, illustrate an embodiment of the invention and together with the description serves to explain the principles of the invention, wherein:

FIG. 1 is a three dimensional view showing the outer appearance of the digital camera according to the present invention.

FIG. 2, is a block diagram illustrating the mutual structural relationship among component parts contained in the digital camera of the present invention.

### DETAILED DESCRIPTION OF THE PREFERRED EMBODIMENT

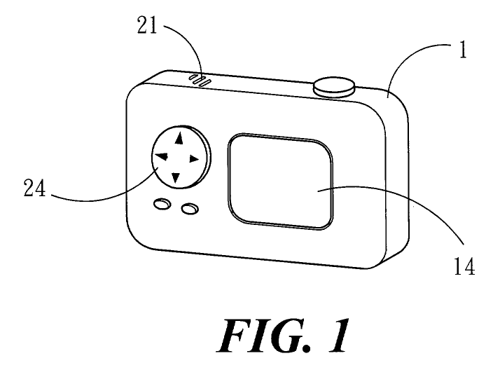

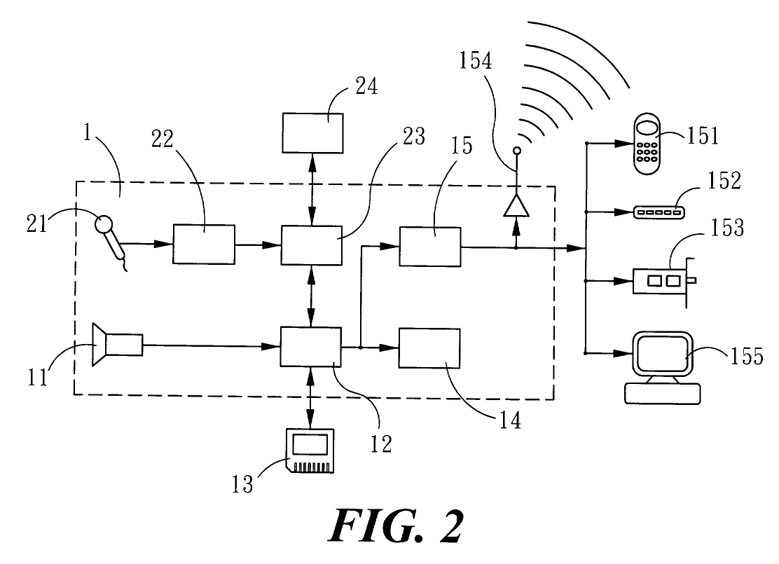

Referring to FIG. 1 together with FIG. 2, the digital camera 1 capable of transforming the audio input to its picture immediately into a readable illustration and transmitting same according to the present invention comprises an image input device 11, an image processing device 12, and a memory 13 for storing the image information. All three of above mentioned devices 11, 12 and 13 belong to conventional installations which will not be discussed herein. The feature of the present invention lies in that it has an audio input device 21, such as a microphone equipped in the digital camera, and the audio input device 21 is connected with a voice identification device 22 constructed of a hardware or a software for reading in the audio signals inputted by the audio input device 21 and then transforming those audio signals into readable characters after identification is made. A processing unit 23 is connected to the voice identification device 22 for controlling operation of a the audio input device 21 and the voice identification device 22 and predetermining the object to transmit by operating operational keys 24, and further recording the characters into a visual window 14 of the image processing device 12 or on a digital picture, and carrying on procedures to follow thereafter.

Meanwhile, the digital picture produced by the image processing device 12 can be displayed on a display screen 14, or transmitted to a cellular phone 151, a data processing unit 152, an internet card 153, a RF transmitter 154, or a computer 155 via a transmission interface 15 according to various transmission agreements such as USB, IEEE1394, Blue Teeth, 802,11b, or even comparatively low speed RS232 for data transmission or image processing so as to attain the final aim of image transmission. With the aid of progress in high technological science and micro mechanical engineering, the aforementioned cellular phone 151, data processing unit 152, internet card 153, and RF transmitter 154 can be built in or installed outside of the digital camera 1 so as to improve the flexibility and conveniency of the products. Further to this, the data processing unit 152 may be replaced by other equivalent devices as a MODEM(modulator-demodulator), data card, or IC etc.

Furthermore, in order to improve preciseness of the output image, the display screen 14 of the present invention is provided with a function capable of directly modifying characters, at first, the voice is recorded by the audio input device 21, thereafter the recorded voice is transformed into a series of characters by the voice identification device 22, and then the result is displayed on the screen 14. Should any error be discovered in the characters by the digital camera operator, the error can be corrected by tapping the operational keys 24 before the characters are affixed to the relevant place on the digital picture.

It emerges from the above description that the digital camera of the present invention has several noteworthy advantages which any conventional digital camera is impossible to attain, i.e. The digital camera of the present invention is capable of transforming the audio input to its picture immediately into a readable characterized illustration and transmitting same by way of existing radio communication system or global internet to a specified receiver or to display on a visual display terminal without loosing fidelity of the picture thereby saving extra manpower and time otherwise may be consumed for preparing supplementary illustration for a silent picture as that produced by the conventional technique.

As the present invention is not limited to the above embodiment, it is clearly understood that many variations can be made within the scope and spirit of the present invention by anyone skilled in the art.

What is claimed is:

1. A digital camera comprising:
an audio input device for inputting audio signals;
a voice identification device connected to said audio input device for receiving said audio signals therefrom, and storing readable characterized information transformed from said audio signals via the procedures of identification and processing using identification software and system elements, in a digital picture;
a transmission interface for transmitting the output digital picture which storing said readable characterized information; and
a processing unit provided with several operational keys on the surface of said digital camera for operating and controlling above mentioned devices.

2. The digital camera of claim 1, wherein said voice identification device is a hardware or a software.

3. The digital camera of claim 1, wherein said transmission interface is connected to several devices built in said digital camera such as a MODEM, a data card, an IC chip, an internet card, a RF transmitter, and a cellular phone.

4. The digital camera of claim 1, wherein said transmission interface is connected to several devices installed outside of said digital camera such as a MODEM, a data card, and IC chip, an internet card, a RF transmitter, and cellular phone.

5. The digital camera of claim 1, wherein said digital camera is equipped with a display screen capable of displaying result of voice identification immediately, and also has several operational keys for modifying or selecting replacement voice or characters so as to output the corrected resultant information to said digital picture for transmission or display.
